(19) United States
(12) Patent Application Publication
(10) Pub. No.: US 2017/0261151 A1
(43) Pub. Date: Sep. 14, 2017

(54) TRIPOD WITH A TRAPAZOIDAL SCREW CONNECTION

(71) Applicant: DOLICA CORPORATION, Rancho Cucamonga, CA (US)

(72) Inventor: Kevin Hsu, Eastvale, CA (US)

(73) Assignee: DOLICA CORPORATION, Rancho Cucamonga, CA (US)

(21) Appl. No.: 15/069,765

(22) Filed: Mar. 14, 2016

(51) Int. Cl. F16M 11/32; F16B 33/02

(52) U.S. Cl. CPC F16M 11/32; F16B 33/02

(57) ABSTRACT

A sand resistant screw connector assembly can be used on the telescoping legs of a tripod assembly. The screw connector may use a trapezoidal thread, such as an Acme thread, for the male and female screw connectors. Such a thread design has been found to help push sand out to assist in cleaning. Therefore, when a tripod is designed using a screw connector having trapezoidal threads, the tripod may be well-suited for use in sandy environments, such as beaches, playgrounds, or the like. Various trapezoidal thread standards may be utilized, including JIS B0216, JIS B0217, JIS B0218, JIS B0222, ANSI B1.5 and ANSI B1.8, for example. The sand resistant screw connector may be used in other application where sand may pose a problem, including beach umbrellas, lawn furniture, beach games, and the like.

### BACKGROUND OF THE INVENTION

1. Field of the Invention

One or more embodiments of the invention relates generally to connectors. More particularly, the invention relates to a screw connector that can provide a sand resistant connection adaptable for use on telescoping legs of a tripod. The connector, using trapezoidal screw threads, helps push sand out for ease of cleaning.

2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Tripods are routinely used for photography and videography. Most tripods have adjustable legs that include multiple segments collapsible into one another.

Many photographers use their equipment to capture the power of the ocean and its effect on sand. In doing so, it is important to bring the camera to the right height to fill the frame with the beach and water while also keeping enough of the horizon so that the viewer can perceive depth. Therefore, a tripod is a necessary accessory for such photographs.

Keeping a clean tripod is important, as sand can get in between the threads of the grip locks, making it harder to achieve a solid lock and preventing the tripod legs from easily retracting. To address this issue, various solutions have been proposed. Many involve the disassembly of the tripod system so that a thorough cleaning can be achieved. Often, various tools, such as a standard toothbrush, are used to remove the finer grains of sand that get stuck in threads even after giving them a good rinse.

Some users go as far as using a plastic material, such as plastic bags, cut into long pieces, with adhesive tape to cover the joints of the tripod like a bandage. While this may keep wind-blown sand from reaching the tripod joints, this method requires the user to prepare and carry with them additional material to the location of the photo shoot. Moreover, once the plastic material is attached, adjustment of the legs of the tripod may be difficult, if not impossible, without removing the plastic material and exposing the joint to sand.

In view of the foregoing, it is clear that there is a need for a tripod having a connector that can help resist sand and simplify cleaning and use of the tripod in environments where sand may be prevalent.

### SUMMARY OF THE INVENTION

Embodiments of the present invention provide a tripod comprising a central member; and a plurality of leg assemblies extending from the central member, each of the plurality of leg assemblies including a first leg portion attached to and extending away from the central member; a second leg portion telescopingly fitting into the first leg portion and extending therefrom; an inner screw connector attached to a distal end of the first leg portion, the inner screw connector having male threads on an exterior thereof; and an outer screw connector rotatable about the second leg portion, the outer screw connector having female threads on an interior thereof, the female threads mating with the male threads, wherein at least one of the male threads and the female threads have a trapezoidal thread form.

The tripod may be designed where both the male threads and the female threads have the trapezoidal thread form. The tripod may be designed where an inner diameter of the inner screw connector permits the second leg portion to fit therein. The tripod may be designed where the outer screw connector has an angled distal end, where an inside diameter of the angled distal end fits about an outer circumference of the second leg portion. The trapezoidal thread form may have a thread angle of about 29 to 30 degrees, and a thread height that is about one-half a thread pitch.

The tripod may include additional leg portions, such as a third leg portion telescopingly fitting into the second leg portion and extending therefrom; a second inner screw connector attached to a distal end of the second leg portion, the second inner screw connector having second male threads on an exterior thereof; and a second outer screw connector rotatable about the third leg portion, the outer second screw connector having second female threads on an interior thereof, the second female threads mating with the second male threads, wherein at least one of the second male threads and the second female threads have a trapezoidal thread form.

Embodiments of the present invention further provide a telescoping assembly comprising at least one leg assembly extending in a first direction, each leg assembly including a first leg portion; a second leg portion telescopingly fitting into the first leg portion and extending therefrom; an inner screw connector attached to a distal end of the first leg portion, the inner screw connector having male threads on an exterior thereof, the distal end being an end from which the second leg portion telescopingly extends; and an outer screw connector rotatable about the second leg portion, the outer screw connector having female threads on an interior thereof, the female threads mating with the male threads, wherein at least one of the male threads and the female threads have a trapezoidal thread form.

Embodiments of the present invention also provide a tripod comprising a central member; and three leg assemblies extending from the central member, each of the three leg assemblies including a first leg portion attached to and extending away from the central member; a second leg portion telescopingly fitting into the first leg portion and extending therefrom; an inner screw connector attached to a distal end of the first leg portion, the inner screw connector having male threads on an exterior thereof, the inner screw connector having an inner diameter permitting the second leg portion to fit therein; and an outer screw connector rotatable about the second leg portion, the outer screw connector having female threads on an interior thereof, the female threads mating with the male threads, the outer screw connector having an angled distal end, where an inside diameter of the angled distal end fits about an outer circumference of the second leg portion, wherein the male threads and the female threads have a trapezoidal thread form.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an exemplary tripod having a sand resistant screw connector assembly according to an exemplary embodiment of the present invention;

FIG. 2 illustrates a perspective view of the sand resistant screw connector assembly usable in the tripod of FIG. 1, in a detached configuration;

FIG. 3 illustrates a perspective view of the sand resistant screw connector assembly usable in the tripod of FIG. 1, in an attached configuration;

FIG. 4 illustrates a side view of the sand resistant screw connector assembly usable in the tripod of FIG. 1, in an attached configuration;

FIG. 5 illustrates a side perspective view of a male screw connector component of the sand resistant screw connector assembly of FIG. 2; and

FIG. 6 illustrates a side cross-sectional view of an exemplary trapezoidal thread used in the sand resistant screw connector assembly of FIG. 2.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Broadly, the present invention provides a screw connector assembly that can be used on the telescoping legs of a tripod assembly. The screw connector may use a trapezoidal thread, such as an Acme thread, for the male and female screw connectors. Such a thread design has been found to help push sand out to assist in cleaning. Therefore, when a tripod is designed using a screw connector having trapezoidal threads, the tripod may be well-suited for use in sandy environments, such as beaches, playgrounds, or the like. Various trapezoidal thread standards may be utilized, including JIS B0216, JIS B0217, JIS B0218, JIS B0222, ANSI B1.5 and ANSI B1.8, for example.

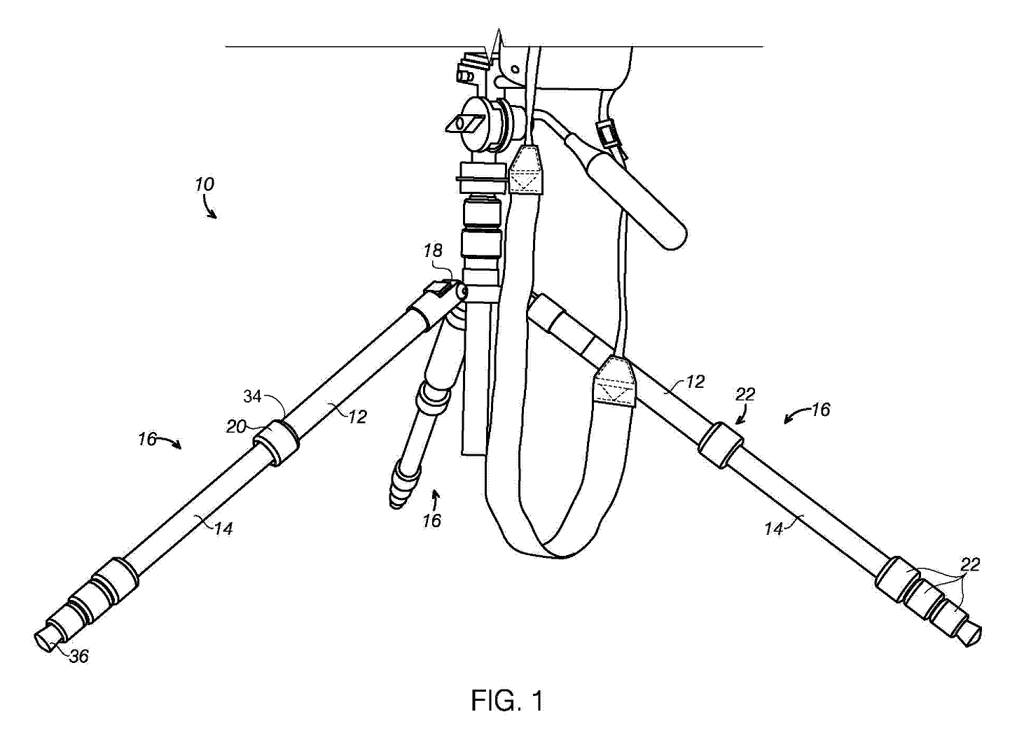

FIG. 1 illustrates an exemplary tripod 10 having three legs 16, where each of the legs 16 include at least a first leg portion 12 and a second leg portion 14. The second leg portion 14 may fit into the first leg portion 12 to create a telescoping action between the first leg portion 12 and the second leg portion 14. To deploy the tripod 10, a user may angle each of the legs 16 away from a tripod central member 18 and adjust each of the legs 16 to an appropriate length by turning an outer screw connector 20 to loosen, extending the second leg portion 14 from the first leg portion 12 a desired length, and tightening the outer screw connector 20. Typically, the tripod 10 can include multiple leg portions, each telescoping into another with a screw connector assembly 22 disposed at distal ends of each leg portion.

While FIG. 1 shows one typical configuration for the tripod 10, other configurations are contemplated within the scope of the present invention. For example, various camera mounts may be attached to the central member 18, various feet may be used at the ends of the legs 16, and the telescoping legs could dispose the least diameter leg adjacent the central member 18, thereby telescoping in an opposite direction, for example. These and other forms and designs of tripods as may be understood by those skilled in the art are usable with the screw connector assembly 22 of the present invention.

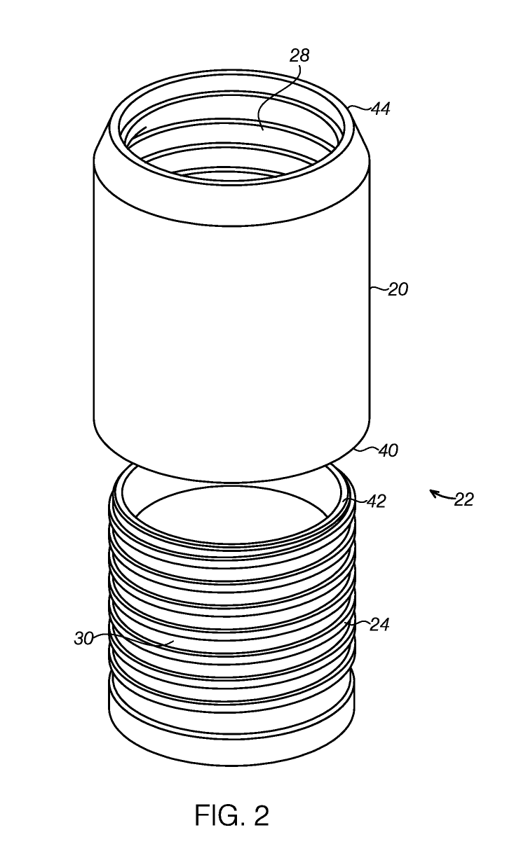

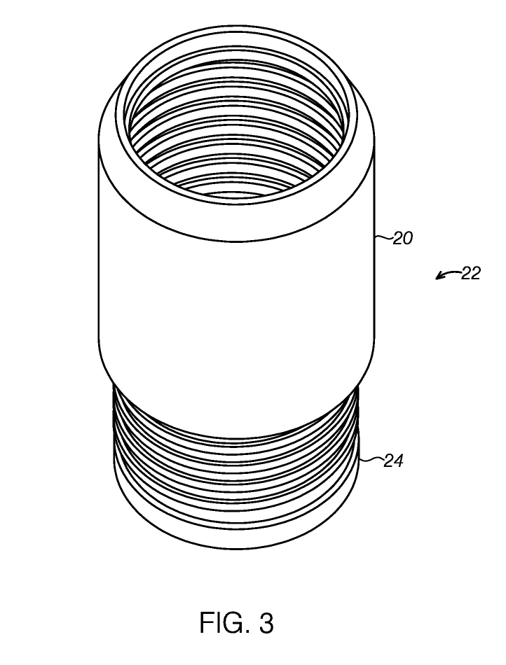

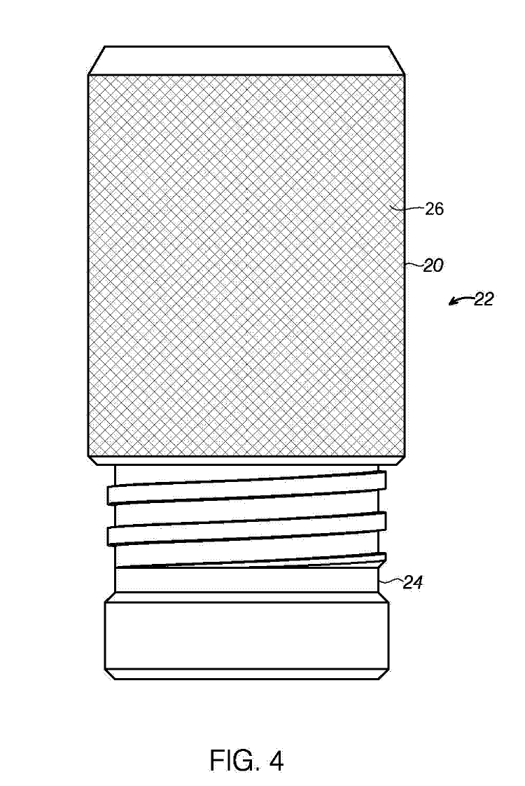

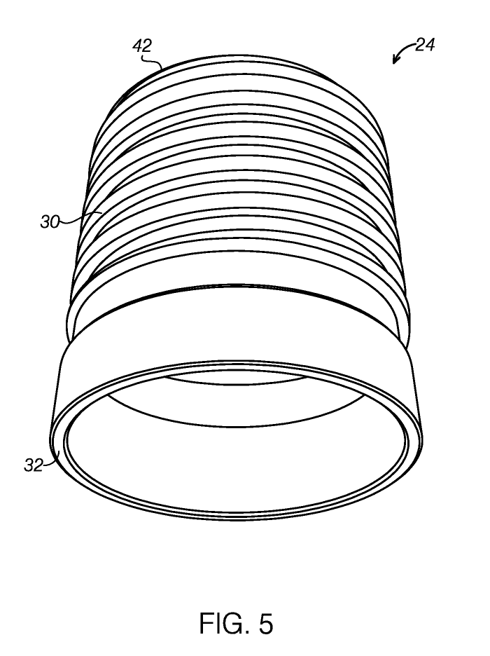

Referring additionally to FIGS. 2 through 6, the screw connector assembly 22 can include the outer screw connector 20 and an inner screw connector 24. The outer screw connector 20 can include a gripping surface 26, such as a roughened outer surface, as shown, or a plurality of protrusions, or the like, to permit a user to grip the outer screw connector 20 and turn the connector as desired to tighten or loosen the telescoping legs 16.

The outer screw connector 20 can include female threads 28 on an interior thereof. The inner screw connector 24 can include male threads 30 on an exterior thereof. The male threads 30 may be configured to mate with the female threads 28, where turning the outer screw connector 20 in a “tightening” direction moves the inner screw connector 24 inside of the outer screw connector 20.

The inner screw connector 24 can have a leg portion attachment end 32 adapted to attach to a distal end 34 (relative to the central member 18) of each leg portion 12, 14 (except for the distal-most leg portion, where a foot member 36 may be attached thereto, for example, as shown in FIG. 1). An inside diameter of the inner screw connector 24 may be slightly larger than an outer diameter of a leg portion immediately distal to the leg portion to which the inner screw connector 24 is attached. This “slightly larger” diameter is sized to permit the immediately distal leg portion to slide inside the inner screw connector 24 and into the larger leg portion. For example, referring back to FIG. 1, the inner screw connector 24 may be disposed on a distal end of the first leg portion 12. The inside diameter of this inner screw connector 24 may be slightly larger than the outer diameter of the second leg portion 14, thereby allowing the second leg portion 14 to fit into the inner screw connector 24 and telescope inside the first leg portion 12.

The outer screw connector 20 can then fit over the second leg portion 14 with its proximate end 40 facing a distal end 42 of the inner screw connector 24. A distal end 44 of the outer screw connector 20 may be angled to provide an inner diameter that is slightly larger than an outer diameter of the second leg portion 14 such that the outer screw connector 20 may be rotated about the second leg portion 14. The angled distal end 44 may also help prevent debris from reaching the mating threads 28, 30 of the screw connector assembly 22.

In use, a user can rotate the outer screw connector 20 to loosen it from the inner screw connector 24. When loosened, the second leg portion 14 may be extended from the first leg portion 12 a desired length. When the outer screw connector 20 is tightened on the inner screw connector 24, the second leg portion 14 is then fixed in a desired extension from the first leg portion 12.

At least one of the male threads 30 on the inner screw connector 24 and the female threads on the outer screw connector 20 may be formed as trapezoidal thread form. In some embodiments, both of the threads 28, 30 may be formed as trapezoidal thread form. It has been found that threads so shaped have the ability to resist debris such as sand. This design can easily push sand out to make cleaning of the tripod easier. In conventional tripod designs, cleaning, often with a toothbrush or other such implement, is required to remove the sand, as the sand can severely impact the performance of typical tripod connectors.

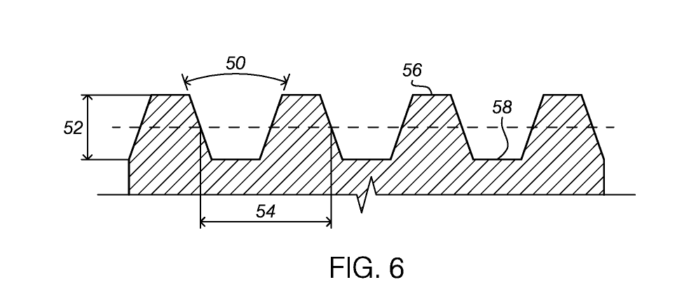

The trapezoidal thread form may be, for example, be an Acme thread form. This thread form is defined as having an angle 50 of about 29-30 degrees, as shown in FIG. 6, a thread height 52 that is about one-half a thread pitch 54, a flattened apex 56 and a flattened valley 58. These threads may be defined by various thread standards, such as JIS B0216, JIS B0217, JIS B0218, JIS B0222, ANSI B1.5 and ANSI B1.8, for example. Unlike conventional square cut threads, which can more easily trap debris, the trapezoidal shaped threads used in the tripod of the present invention may help more easily allow debris, such as sand, to move away from the threads and not pose a problem.

While the above describes a tripod having a screw connector assembly with a trapezoidal thread form, the screw connector assembly may be useful in any telescoping assembly, especially those that may be used outdoors where sand may be an issue. As non-limiting examples, the screw connector assembly may be useful for telescoping assemblies used for beach umbrellas, sporting nets or goals, and the like.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A tripod comprising:
a central member; and
a plurality of leg assemblies extending from the central member, each of the plurality of leg assemblies including:
a first leg portion attached to and extending away from the central member;
a second leg portion telescopingly fitting into the first leg portion and extending therefrom;
an inner screw connector attached to a distal end of the first leg portion, the inner screw connector having male threads on an exterior thereof; and
an outer screw connector rotatable about the second leg portion, the outer screw connector having female threads on an interior thereof, the female threads mating with the male threads, wherein
each of the male threads and the female threads have a trapezoidal thread form with a constant diameter for the male threads.

2. (canceled)

3. The tripod of claim A1, wherein an inner diameter of the inner screw connector permits the second leg portion to fit therein.

4. The tripod of claim 1, wherein the outer screw connector has an angled distal end, where an inside diameter of the angled distal end fits about an outer circumference of the second leg portion.

5. The tripod of claim 1, wherein the trapezoidal thread form has a thread angle of about 29 to 30 degrees.

6. The tripod of claim 1, wherein the trapezoidal thread form has a thread height that is about one-half a thread pitch.

7. The tripod of claim 1, wherein each of the plurality of leg assemblies further includes:
a third leg portion telescopingly fitting into the second leg portion and extending therefrom;
a second inner screw connector attached to a distal end of the second leg portion, the second inner screw connector having second male threads on an exterior thereof; and
a second outer screw connector rotatable about the third leg portion, the outer second screw connector having second female threads on an interior thereof, the second female threads mating with the second male threads, wherein
at least one of the second male threads and the second female threads have a trapezoidal thread form.

8. The tripod of claim 7, wherein each of the plurality of leg assemblies further includes:
a fourth leg portion telescopingly fitting into the third leg portion and extending therefrom;
a third inner screw connector attached to a distal end of the third leg portion, the third inner screw connector having third male threads on an exterior thereof; and
a third outer screw connector rotatable about the fourth leg portion, the outer second screw connector having third female threads on an interior thereof, the third female threads mating with the third male threads, wherein
at least one of the third male threads and the third female threads have a trapezoidal thread form.

9. A telescoping assembly comprising:
at least one leg assembly extending in a first direction, each of the at least one leg assembly including:
a first leg portion;
a second leg portion telescopingly fitting into the first leg portion and extending therefrom;
an inner screw connector attached to a distal end of the first leg portion, the inner screw connector having male threads on an exterior thereof, the distal end being an end from which the second leg portion telescopingly extends; and
an outer screw connector rotatable about the second leg portion, the outer screw connector having female threads on an interior thereof, the female threads mating with the male threads, wherein
each of the male threads and the female threads have a trapezoidal thread form and the male threads have a constant thread diameter.

10. (canceled)

11. The tripod of claim 9, wherein an inner diameter of the inner screw connector permits the second leg portion to fit therein.

12. The tripod of claim 9, wherein the outer screw connector has an angled distal end, where an inside diameter of the angled distal end fits about an outer circumference of the second leg portion.

13. The tripod of claim 9, wherein the trapezoidal thread form has a thread angle of about 29 to 30 degrees.

14. The tripod of claim 9, wherein the trapezoidal thread form has a thread height that is about one-half a thread pitch.

15. A tripod comprising:
a central member; and
three leg assemblies extending from the central member, each of the three leg assemblies including:
a first leg portion attached to and extending away from the central member;
a second leg portion telescopingly fitting into the first leg portion and extending therefrom;
an inner screw connector attached to a distal end of the first leg portion, the inner screw connector having male threads on an exterior thereof, the inner screw connector having an inner diameter permitting the second leg portion to fit therein; and
an outer screw connector rotatable about the second leg portion, the outer screw connector having female threads on an interior thereof, the female threads mating with the male threads, the outer screw connector having an angled distal end, where an inside diameter of the angled distal end fits about an outer circumference of the second leg portion, wherein
the male threads and the female threads have a trapezoidal thread form.

16. The tripod of claim 15, wherein the trapezoidal thread form has a thread angle of about 29 to 30 degrees.

17. The tripod of claim 15, wherein the trapezoidal thread form has a thread height that is about one-half a thread pitch.
